(19) United States
(12) Patent Application Publication
(10) Pub. No.: US 2025/0028992 A1
(43) Pub. Date: Jan. 23, 2025

(54) FINE-TUNED MODEL TO SOURCE FOUNDATION MODEL ATTRIBUTION

(71) Applicant: International Business Machines Corporation, Armonk, NY (US)

(72) Inventors: Myles Foley, London (GB); Ambrish Rawat, Dublin (IE); Gabriele Picco, Dublin (IE); Giulio Zizzo, Dublin (IE); Taesung Lee, Ridgefield, CT (US); Yufang Hou, Dublin (IE)

(73) Assignee: International Business Machines Corporation, Armonk, NY (US)

(21) Appl. No.: 18/223,134

(22) Filed: Jul. 18, 2023

(51) Int. Cl. G06N 20/00

(52) U.S. Cl. CPC G06N 20/00

(57) ABSTRACT

An embodiment causes generating, by a trained model, a training prompt response to a training prompt in a set of training prompts. An embodiment trains, using the training prompt and the training prompt response, an attribution model, the training resulting in a trained attribution model. An embodiment attributes, using the trained attribution model and a first prompt response generated by a fine-tuned model in response to a prompt, the fine-tuned model to a foundation model.

### BACKGROUND

The present invention relates generally to machine learning model management. More particularly, the present invention relates to a method, system, and computer program for fine-tuned model to source foundation model attribution.

A foundation model, or base model, is a machine learning model that is trained, generally using self-supervision or semi-supervised learning. After training, a foundation model has general knowledge, but not necessarily knowledge of a specific knowledge domain or a specific task. A fine-tuned model, or derived model, is an adaptation of a foundation model to a specific knowledge domain or task. For example, a large language model (LLM) is generally trained, using a large corpus of text on a variety of topics, to predict the next few words in a sentence or fill in a missing word in a template sentence. Some examples of presently available LLMs are the Generative Pre-trained Transformer (GPT) family of models, such as GPT-3 and GPT-4. (GPT-3 is a registered trademark of OpenAI GP, LLC in the United States and other countries. GPT-4 is a registered trademark of OpenAI OpCo, LLC in the United States and other countries.) Bidirectional Encoder Representations from Transformers (BERT), ROBERTa (an extension of BERT with a different pre-training procedure), Denoising Autoencoder from Transformer (BART), and BigScience Large Open-science Open-access Multilingual Language Model (BLOOM) are also examples of presently available LLMs. A fine-tuned model adapts a trained LLM to a specific task (e.g., part of speech analysis or sentiment analysis), a specific knowledge domain (e.g., a different human language from the original corpus, or a vocabulary used in a particular subject matter area such as medicine or economics), or a combination. As another example, an image processing model might be trained using a large database of images, then adapted into fine-tuned models that perform facial recognition or recognize possible tumors in medical imagery. Because training a foundation model requires significantly more training data and computational resources than generating a fine-tuned model from an existing foundation model, fine-tuned models have proliferated (e.g., more than 120,000 are presently hosted on one site), most derived from a few popular foundation models.

Fine-tuned model to source foundation model attribution is the task of linking, or attributing, a given fine-tuned model to the foundation model from which the fine-tuned model was derived. Typically, the models are treated as black boxes, with no access to internal information such as model source code, and thus fine-tuned model to source foundation model attribution is typically performed using generated responses from one or more of the models.

### SUMMARY

The illustrative embodiments provide for fine-tuned model to source foundation model attribution. An embodiment includes causing generating, by a trained model, a training prompt response to a training prompt in a set of training prompts. An embodiment includes training, using the training prompt and the training prompt response, an attribution model, the training resulting in a trained attribution model. An embodiment includes attributing, using the trained attribution model and a first prompt response generated by a fine-tuned model in response to a prompt, the fine-tuned model to a foundation model. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for loading of process software in accordance with an illustrative embodiment;

FIG. 3 depicts a block diagram of an example configuration for fine-tuned model to source foundation model attribution in accordance with an illustrative embodiment;

FIG. 4 depicts an example of fine-tuned model to source foundation model attribution in accordance with an illustrative embodiment;

FIG. 5 depicts a continued example of fine-tuned model to source foundation model attribution in accordance with an illustrative embodiment;

FIG. 6 depicts a continued example of fine-tuned model to source foundation model attribution in accordance with an illustrative embodiment; and

FIG. 7 depicts a flowchart of an example process for fine-tuned model to source foundation model attribution in accordance with an illustrative embodiment.

### DETAILED DESCRIPTION

The illustrative embodiments recognize that, while the proliferation of fine-tuned models has improved performance of downstream applications such as text summarization and dialogue systems, fine-tuned models can also be sources of misinformation, and can disseminate misinformation at scale through the creation of false majority opinions that are taken by other models as fact. In response, there has been an increased demand (in laws, regulations, and voluntary compliance schemes) to track and report the provenance of fine-tuned models. It is also difficult to track the use of intellectual property through foundation and fine-tuned models to ensure compliance with intellectual property licensing agreements and applicable laws. Thus, the illustrative embodiments recognized that there is a need for fine-tuned model to source foundation model attribution as part of model and data transparency and traceability schemes.

The present disclosure addresses the deficiencies described above by providing a process (as well as a system, method, machine-readable medium, etc.) that generates, by a trained model, a training prompt response to a training prompt, uses the training prompt and the training prompt response to train an attribution model, and uses the trained attribution model and a first prompt response generated by a fine-tuned model in response to a prompt to attribute the fine-tuned model to a foundation model. Thus, the illustrative embodiments provide for fine-tuned model to source foundation model attribution.

An embodiment receives a set of training prompts to be used in training an attribution model to attribute a fine-tuned model to a source foundation model. A prompt is an input to a foundation or fine-tuned model, and a prompt response is the model's output in response to a prompt. Thus, prompts and corresponding prompt responses are examples of a particular model's behavior. For example, a prompt to ChatGPT (a fine-tuned LLM) might be “how were you trained”, and a corresponding prompt response might be “I was trained using a machine learning model called GPT-3.” (ChatGPT is a registered trademark of OpenAI OpCo. LLC in the United States and other countries.) Corpora of prompts that are usable as training prompts are presently available. An embodiment stores a set of training prompts in a prompt datastore.

An embodiment selects a training prompt from the set of training prompts. To select a training prompt, one embodiment compares different corpora of existing training prompts, and selects one or more prompts that are useful to distinguish between models because the prompts have not been used in training many models, or at least not used in training some models. For example, if the same or similar prompts were used in training all the models an embodiment seeks to distinguish, the prompt might not be useful in distinguishing between the models. As another example, if one training corpus include prompts in one particular language while other corpora do not, using some prompts in that language can be useful in distinguishing between a base models trained on that particular corpus and a base model that was not trained on that particular corpus. One embodiment receives a user's manual selection of one or more corpora of training prompts, and selects training prompts randomly using a presently available pseudo-random number generation technique. Another embodiment uses perplexity, a presently available measurement of how well a model predicts a sample, to find model-distinguishing prompts. A base model not trained with a particular prompt is expected to have a higher perplexity (or loss/generation probability) than a base model that is trained with a particular prompt. Another embodiment, as described elsewhere herein with reference to a prompt selection agent, uses a presently available machine learning method, such as reinforcement learning with a goal to maximize the final classification accuracy, or a presently available generative model, to learn to select a training prompt.

An embodiment applies a selected training prompt to a trained fine-tuned model, causing the trained model to generate a training prompt response to the input training prompt. Another embodiment applies a training prompt in the set of training prompts to both a trained fine-tuned model and a trained foundation model, causing the trained model to generate two training prompt responses (one from each model) to the input training prompt. An embodiment interfaces with a trained fine-tuned or foundation model using a presently available technique such as an application program interface (API). An embodiment labels a generated prompt response with the model that generated the prompt response.

An embodiment uses one or more training prompt responses, or combinations of training prompts and their corresponding responses, to train an attribution model to attribute a fine-tuned model to a source foundation model. In some embodiments, the attribution model is a classifier model that outputs a classification of a fine-tuned model to a source foundation model, and a confidence score in the classification. In one embodiment, the prompt responses used for training are outputs from one or more fine-tuned models. In another embodiment, the prompt responses used for training are outputs from one or more foundation models. In another embodiment, the prompt responses used for training are pairs of outputs, one output from a foundation model and the other output from a fine-tuned model derived from the foundation model. To prepare input to the attribution model, an embodiment concatenates a prompt and its prompt response(s) together, then uses an embedding model to generate an embedding (i.e., a numerical representation of the concatenated input). For example, if the attribution model is being trained to classify LLMs, an embodiment uses an existing foundation LLM model (e.g., BERT) to generate embeddings representing the concatenated text of a prompt and its response(s). As another example, if the attribution model is being trained to classify image processing models, an embodiment uses an existing foundation image processing model to generate embeddings representing prompts and responses in image form.

In one embodiment, the attribution model includes a set of binary classifiers in parallel with each other. During training, the embodiment uses a presently available model training technique to train the classifiers to make binary predictions, by adjusting model weights to minimize cross-entropy loss. Each binary prediction is a classification of a training input as either attributed to a particular foundation model or not attributed to that particular foundation model, with a confidence score in the attribution. A prompt response that is attributed to a particular foundation model, with above a threshold confidence value (a positive prompt response), is repurposed as a negative prompt response, during an additional training cycle, for the rest of the classifiers.

In another embodiment, the attribution model is implemented using TripletNet-based classifiers that use a margin-based loss function using the separate embeddings of the base and fine-tuned model responses. TripletNet is a presently available technique that is able to make predictions by taking in a single sentence or other portion of text, computing an output embedding (a numerical representation of a prompt response), and finding the closest embedding from the prompt responses in the training set and using the label of the training sentence as a prediction. The cosine distance between the anchor input (a reference input used in the loss function), positive example (a prompt pair or a prompt-response pair with correct attribution), and negative example (a prompt pair or a prompt-response pair with incorrect attribution is computed as the loss function (the value that the machine learning training procedure tries to minimize—e.g., cos (anchor, negative) and -cos (anchor, positive) for TripleNet).

An embodiment uses the trained attribution model to generate one or more additional training prompts to be used to further train the attribution model. In particular, an embodiment receives, as input, prompts or a vocabulary from which prompts can be generated, or a combination of prompts and a vocabulary. A vocabulary is a collection or set of portions of data that could be assembled into a prompt. For example, if a prompt is a portion of text, a corresponding vocabulary includes words that could be assembled into a prompt. However, a vocabulary need not be limited to text words. For example, if a prompt is an image or portion of an image, a corresponding vocabulary includes images, or portions of images, that could be assembled into a prompt.

A prompt selection agent of an embodiment selects one or more portions of the vocabulary, and uses a presently available technique to generate a prompt from the selected portion(s) of the vocabulary. For example, if a generated prompt is to be a portion of text, an embodiment uses a presently available LLM such as BERT, BART, or BLOOM to generate the portion of text. An embodiment submits the generated prompt to one or more fine-tuned and foundation models the attribution model is being trained to attribute. An embodiment submits prompts and labelled prompt responses produced by the one or more models in response to the generated prompt to the attribution model in a manner described herein. An embodiment uses the attribution model's classification to inform the reinforcement learning method of the performance of the prompt via a reward, using a presently available reinforcement learning technique such as Deep Q-Network, Proximal Policy Optimization, and Synchronous Advantage Actor-Critic. An embodiment periodically optimizes the prompt selection agent by backpropagation using the reward and a loss function, for example using a presently available semi-supervised learning technique such as Deep Q-Network. An embodiment repeats the prompt generation and selection until a training completion criterion is satisfied.

Another embodiment, starting from a word or other portion of a vocabulary, uses a generative model, a presently available technique, to generate a prompt from the starting word. An embodiment submits the generated prompt to one or more fine-tuned and foundation models the attribution model is being trained to attribute. An embodiment submits prompts and labelled prompt responses produced by the one or more models in response to the generated prompt to the attribution model in a manner described herein. An embodiment uses the attribution model's classification of the prompt (e.g., attributed/not attributed) and the actual label (attributed/not attributed) as a loss, and uses a presently available technique to backpropagate over the generative language using the loss function. Backpropagation is a presently available machine learning technique. For example, backpropagation of the attribution model's classification of the prompt can be done by computing the loss of the attribution model based on the prompt. Suppose the attribution model is M, and the generated prompts are G(S), where G is the generative model and S is a word, phrase, or other portion of the vocabulary that works as a seed. This can be empty, or noisy vector depending on how the model is trained and the input modality. Loss can be represented as Loss (M(G(S)), labels) where labels are true values, and M(G(S)) is the output of the attribution method. Loss( . . . ) can be, for example, a cross entropy function. Backpropagation updates the model based on the gradient of the loss function, for example by updating a weight in the model with -eta * gradient(Loss( . . . )) where cta is a learning rate parameter. Other backpropagation and machine learning implementations are also possible and contemplated within the scope of the illustrative embodiments. An embodiment repeats the prompt generation and selection until a training completion criterion is satisfied.

An embodiment uses a trained attribution model and a prompt response generated by a fine-tuned model in response to a prompt to attribute the fine-tuned model to a foundation model. In some embodiments, the trained attribution model outputs a classification of a fine-tuned model to a source foundation model, and a confidence score in the classification. In one embodiment, the prompt response is an output from one or more fine-tuned models. In another embodiment, the prompt response is a pair of outputs, one output from a fine-tuned model and the other output from a foundation model, and the embodiment seeks to attribute the fine-tuned model to the foundation model.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

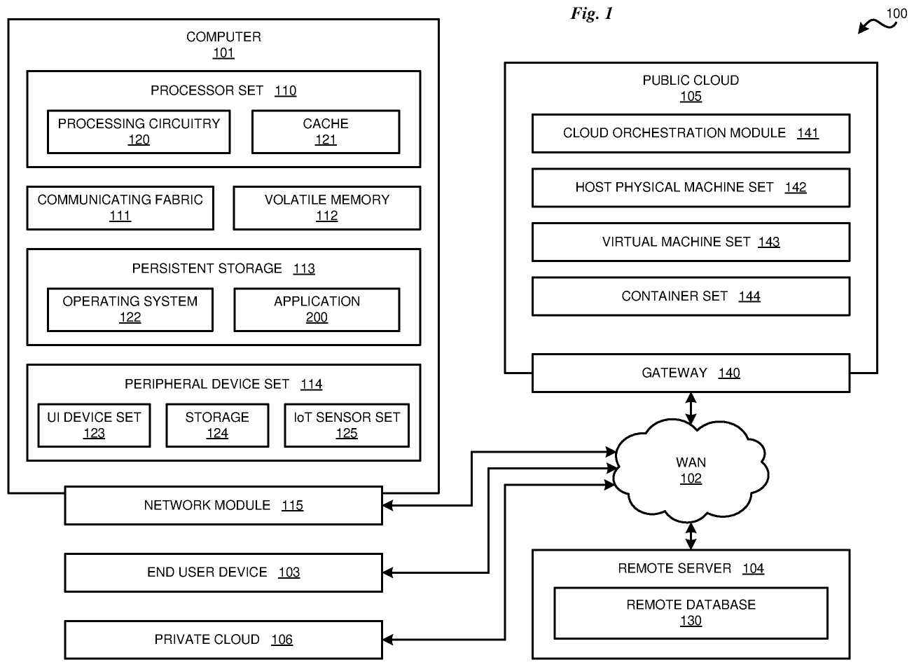

With reference to FIG. 1, this figure depicts a block diagram of a computing environment 100. Computing environment 100 contains an example of an environment for the execution of at least some of the computer code involved in performing the inventive methods, such as an embodiment performing fine-tuned model to source foundation model attribution. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

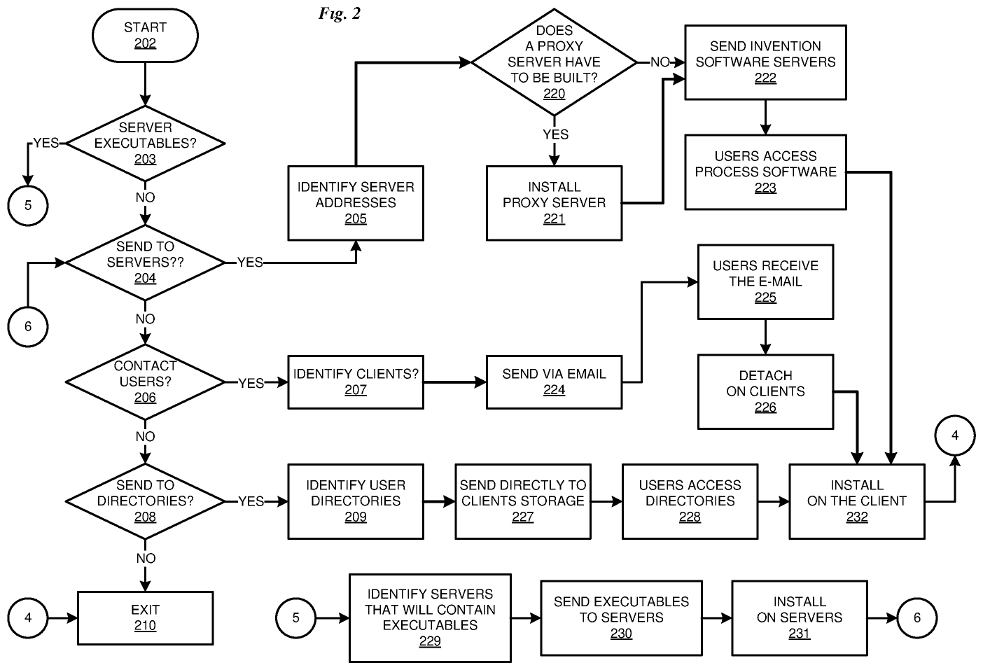

With reference to FIG. 2, this figure depicts a flowchart of an example process for loading of process software in accordance with an illustrative embodiment. The flowchart can be executed by a device such as computer 101, end user device 103, remote server 104, or a device in private cloud 106 or public cloud 105 in FIG. 1.

While it is understood that the process software implementing fine-tuned model to source foundation model attribution in accordance with an illustrative embodiment may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 202 begins the deployment of the process software. An initial step is to determine if there are any programs that will reside on a server or servers when the process software is executed (203). If this is the case, then the servers that will contain the executables are identified (229). The process software for the server or servers is transferred directly to the servers' storage via FTP or some other protocol or by copying though the use of a shared file system (230). The process software is then installed on the servers (231).

Next, a determination is made on whether the process software is to be deployed by having users access the process software on a server or servers (204). If the users are to access the process software on servers, then the server addresses that will store the process software are identified (205).

A determination is made if a proxy server is to be built (220) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (221). The process software is sent to the (one or more) servers either via a protocol such as FTP, or it is copied directly from the source files to the server files via file sharing (222). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (223). Another embodiment is to have the servers automatically copy the process software to each client and then run the installation program for the process software at each client computer. The user executes the program that installs the process software on his client computer (232) and then exits the process (210).

In step 206 a determination is made whether the process software is to be deployed by sending the process software to users via e-mail. The set of users where the process software will be deployed are identified together with the addresses of the user client computers (207). The process software is sent via e-mail to each of the users' client computers (224). The users then receive the e-mail (225) and then detach the process software from the e-mail to a directory on their client computers (226). The user executes the program that installs the process software on his client computer (232) and then exits the process (210).

Lastly, a determination is made on whether the process software will be sent directly to user directories on their client computers (208). If so, the user directories are identified (209). The process software is transferred directly to the user's client computer directory (227). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (228). The user executes the program that installs the process software on his client computer (232) and then exits the process (210).

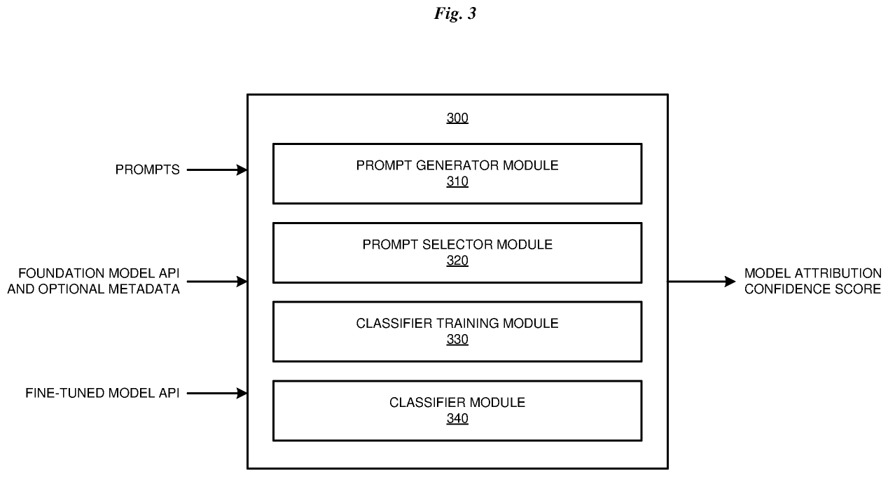

With reference to FIG. 3, this figure depicts a block diagram of an example configuration for fine-tuned model to source foundation model attribution in accordance with an illustrative embodiment. Application 300 is the same as application 200 in FIG. 1.

In the illustrated embodiment, application 300 receives a set of training prompts to be used in training an attribution model to attribute a fine-tuned model to a source foundation model. A prompt is an input to a foundation or fine-tuned model, and a prompt response is the model's output in response to a prompt. Thus, prompts and corresponding prompt responses are examples of a particular model's behavior. For example, a prompt to ChatGPT (a fine-tuned LLM) might be “how were you trained”, and a corresponding prompt response might be “I was trained using a machine learning model called GPT-3.” Corpora of prompts that are usable as training prompts are presently available. An embodiment stores a set of training prompts in a prompt datastore.

Prompt selector module 320 selects a training prompt from the set of training prompts. To select a training prompt, one implementation of module 320 compares different corpora of existing training prompts, and selects one or more prompts that are useful to distinguish between models because the prompts have not been used in training many models, or at least not used in training some models. One implementation of module 320 receives a user's manual selection of one or more corpora of training prompts, and selects training prompts randomly using a presently available pseudo-random number generation technique. Another implementation of module 320 uses perplexity, a presently available measurement of how well a model predicts a sample, to find model-distinguishing prompts. A base model not trained with a particular prompt is expected to have a higher perplexity (or loss/generation probability) than a base model that is trained with a particular prompt. Another implementation of module 320, as described elsewhere herein with reference to a prompt selection agent, uses a presently available machine learning method, such as reinforcement learning with a goal to maximize the final classification accuracy, or a presently available generative model, to learn to select a training prompt.

Classifier training module 330 applies a selected training prompt to a trained fine-tuned model, causing the trained model to generate a training prompt response to the input training prompt. Another implementation of module 330 applies a training prompt in the set of training prompts to both a trained fine-tuned model and a trained foundation model, causing the trained model to generate two training prompt responses (one from each model) to the input training prompt. Application 300 interfaces with a trained fine-tuned or foundation model using a presently available technique such as an application program interface (API). Module 330 labels a generated prompt response with the model that generated the prompt response.

Module 330 uses one or more training prompt responses, or combinations of training prompts and their corresponding responses, to train an attribution model to attribute a fine-tuned model to a source foundation model. In some implementations of application 300, the attribution model is a classifier model that outputs a classification of a fine-tuned model to a source foundation model, and a confidence score in the classification. In one implementation of module 330, the prompt responses used for training are outputs from one or more fine-tuned models. In another implementation of module 330, the prompt responses used for training are outputs from one or more foundation models. In another implementation of module 330, the prompt responses used for training are pairs of outputs, one output from a foundation model and the other output from a fine-tuned model derived from the foundation model. To prepare input to the attribution model, application 300 concatenates a prompt and its prompt response(s) together, then uses an embedding model to generate an embedding (i.e., a numerical representation of the concatenated input). For example, if the attribution model is being trained to classify LLMs, application 300 uses an existing foundation LLM model (e.g., BERT) to generate embeddings representing the concatenated text of a prompt and its response(s). As another example, if the attribution model is being trained to classify image processing models, application 300 uses an existing foundation image processing model to generate embeddings representing prompts and responses in image form.

In one implementation of application 300, the attribution model includes a set of binary classifiers in parallel with each other. During training, module 330 uses a presently available model training technique to train the classifiers to make binary predictions, by adjusting model weights to minimize cross-entropy loss. Each binary prediction is a classification of a training input as either attributed to a particular foundation model or not attributed to that particular foundation model, with a confidence score in the attribution. A prompt response that is attributed to a particular foundation model, with above a threshold confidence value (a positive prompt response), is repurposed as a negative prompt response, during an additional training cycle, for the rest of the classifiers.

In another implementation of application 300, the attribution model is implemented using TripletNet-based classifiers that use a margin-based loss function using the separate embeddings of the base and fine-tuned model responses. TripletNet is a presently available technique that is able to make predictions by taking in a single sentence or other portion of text, computing an output embedding (a numerical representation of a prompt response), and finding the closest embedding from the prompt responses in the training set and using the label of the training sentence as a prediction. The cosine distance between the anchor input (a reference input used in the loss function), positive example (a prompt pair or a prompt-response pair with correct attribution), and negative example (a prompt pair or a prompt-response pair with incorrect attribution is computed as the loss function (the value that the machine learning training procedure tries to minimize—e.g., cos (anchor, negative) and -cos (anchor, positive) for TripleNet).

Prompt generator module 310 uses the trained attribution model to generate additional training prompts to be used to further train the attribution model. In particular, module 310 receives, as input, prompts or a vocabulary from which prompts can be generated. A vocabulary is a collection or set of portions of data that could be assembled into a prompt. For example, if a prompt is a portion of text, a corresponding vocabulary includes words that could be assembled into a prompt. However, a vocabulary need not be limited to text words. For example, if a prompt is an image or portion of an image, a corresponding vocabulary includes images, or portions of images, that could be assembled into a prompt.

A prompt selection agent of an implementation of module 310 selects one or more portions of the vocabulary, and uses a presently available technique to generate a prompt from the selected portion(s) of the vocabulary. For example, if a generated prompt is to be a portion of text, module 310 uses a presently available LLM such as BERT, BART, or BLOOM to generate the portion of text. Module 310 submits the generated prompt to one or more fine-tuned and foundation models the attribution model is being trained to attribute. Module 310 submits prompts and labelled prompt responses produced by the one or more models in response to the generated prompt to the attribution model in a manner described herein. Module 310 uses the attribution model's classification to inform the reinforcement learning method of the performance of the prompt via a reward, using a presently available reinforcement learning technique such as Deep Q-Network, Proximal Policy Optimization, and Synchronous Advantage Actor-Critic. Module 310 periodically optimizes the prompt selection agent by backpropagation using the reward and a loss function, for example using a presently available semi-supervised learning technique such as Deep Q-Network. Module 310 repeats the prompt generation and selection until a training completion criterion is satisfied.

Another implementation of module 310, starting from a word or other portion of a vocabulary, uses a generative model, a presently available technique, to generate a prompt from the starting word. Module 310 submits the generated prompt to one or more fine-tuned and foundation models the attribution model is being trained to attribute. Module 310 submits prompts and labelled prompt responses produced by the one or more models in response to the generated prompt to the attribution model in a manner described herein. Module 310 uses the attribution model's classification of the prompt (e.g., attributed/not attributed) and the actual label (attributed/not attributed) as a loss, and uses a presently available technique to backpropagate over the generative language using the loss function. For example, backpropagation of the attribution model's classification of the prompt can be done by computing the loss of the attribution model based on the prompt. Suppose the attribution model is M, and the generated prompts are G(S), where G is the generative model and S is a word, phrase, or other portion of the vocabulary that works as a seed. This can be empty, or noisy vector depending on how the model is trained and the input modality. Loss can be represented as Loss (M(G(S)), labels) where labels are true values, and M(G(S)) is the output of the attribution method. Loss( . . . ) can be, for example, a cross entropy function. Backpropagation updates the model based on the gradient of the loss function, for example by updating a weight in the model with -eta * gradient(Loss( . . . )) where eta is a learning rate parameter. Other backpropagation and machine learning implementations are also possible Module 310 repeats the prompt generation and selection until a training completion criterion is satisfied.

Classifier module 340 uses a trained attribution model and a prompt response generated by a fine-tuned model in response to a prompt to attribute the fine-tuned model to a foundation model. In some implementations of module 340, the trained attribution model outputs a classification of a fine-tuned model to a source foundation model, and a confidence score in the classification. In one implementation of module 340, the prompt response is an output from one or more fine-tuned models. In another implementation of module 340, the prompt response is a pair of outputs, one output from a fine-tuned model and the other output from a foundation model, and the implementation seeks to attribute the fine-tuned model to the foundation model.

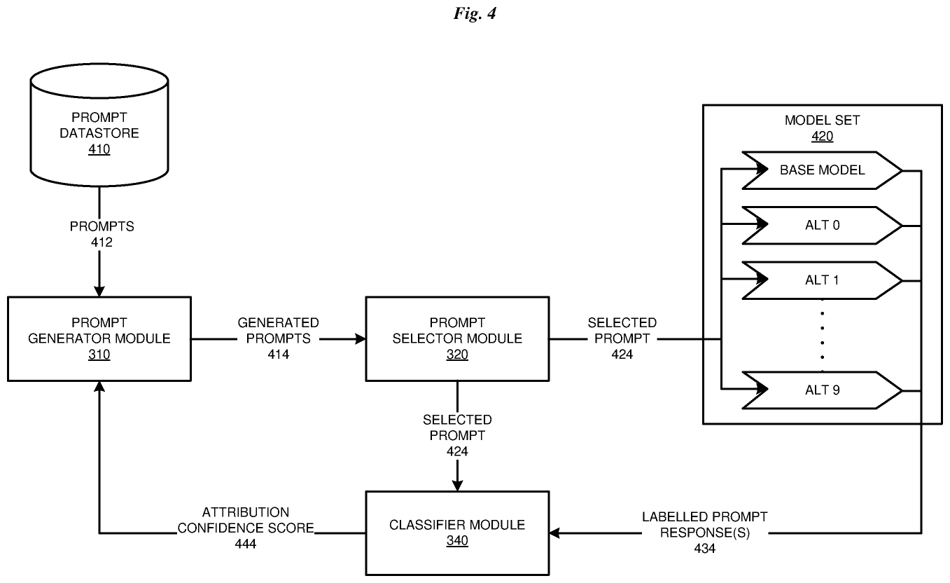

With reference to FIG. 4, this figure depicts an example of fine-tuned model to source foundation model attribution in accordance with an illustrative embodiment. The example can be executed using application 300 in FIG. 3. Prompt generator module 310, prompt selector module 320, and classifier module 340 are the same as prompt generator module 310, prompt selector module 320, and classifier module 340 in FIG. 3.

As depicted, prompt generator module 310 uses prompts 412 from prompt datastore 410, as well as a vocabulary from which prompts can be generated, to generate generated prompts 414. Prompt selector module 320 submits selected prompt 424 to model set 420, one or more fine-tuned and foundation models the attribution model is being trained to attribute, resulting in labelled prompt response(s) 434. Classifier module 340 submits selected prompt 424 and labelled prompt response(s) 434 to the attribution model, which produces attribution confidence score 444. Prompt generation module 310 uses attribution confidence score 444 to update prompt generation, and repeats the prompt generation and selection until a training completion criterion is satisfied.

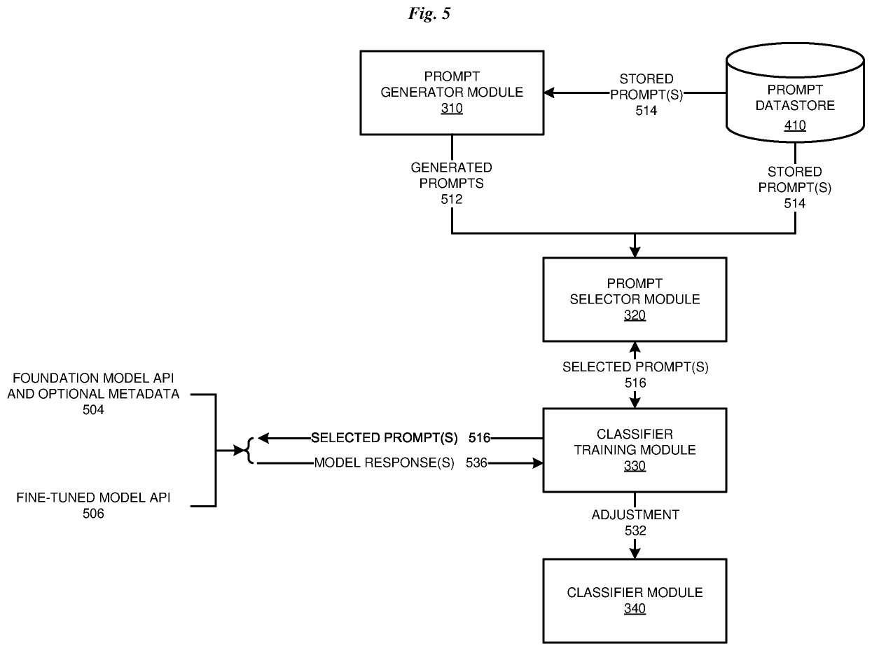

With reference to FIG. 5, this figure depicts a continued example of fine-tuned model to source foundation model attribution in accordance with an illustrative embodiment. Prompt generator module 310, prompt selector module 320, classifier training module 330, and classifier module 340 are the same as prompt generator module 310, prompt selector module 320, classifier training module 330, and classifier module 340 in FIG. 3. Prompt datastore 410 is the same as prompt datastore 410 in FIG. 4.

As depicted, prompt generator module 310 uses stored prompts 514 from prompt datastore 410 to generate generated prompts 512. Prompt selector module 320 submits selected prompt(s) 516 (from generated prompts 512 and stored prompts 514) to classifier training module 330. Module 330 applies one or more of selected training prompt(s) 516 to one or more of foundation model API 504 and fine-tuned model API 506, causing the trained model(s) to generate model response(s) 536. Module 330 uses selected prompt(s) 516 and model response(s) 536 to train an attribution model to attribute a fine-tuned model to a source foundation model, via adjustment 532 to the model in classifier module 340.

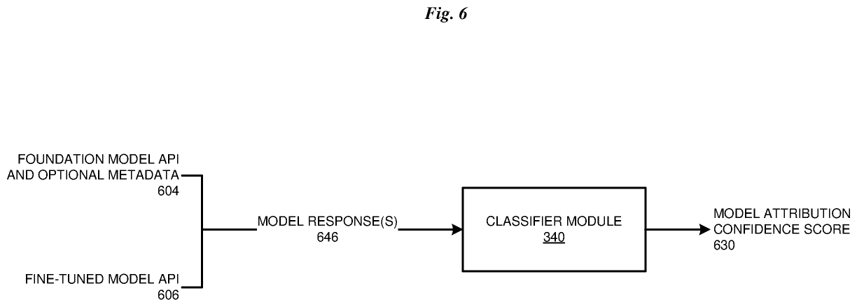

With reference to FIG. 6, this figure depicts a continued example of fine-tuned model to source foundation model attribution in accordance with an illustrative embodiment. Classifier module 340 is the same as classifier module 340 in FIG. 3.

As depicted, classifier module 340 uses a trained attribution model and one or more model responses 646 (from foundation model API 604, fine-tuned model API 606, or both) to attribute the fine-tuned model to a foundation model. Classifier module 340 outputs model attribution confidence score 630, a classification of a fine-tuned model to a source foundation model and a confidence score in the classification.

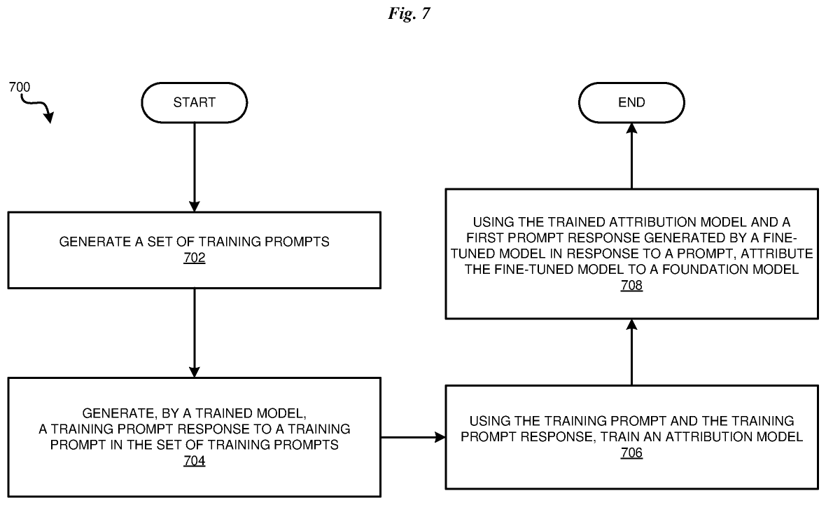

With reference to FIG. 7, this figure depicts a flowchart of an example process for fine-tuned model to source foundation model attribution in accordance with an illustrative embodiment. Process 700 can be implemented in application 200 in FIG. 3.

In the illustrated embodiment, at block 702, the process generates a set of training prompts. At block 704, the process generates, or causes generating of by a trained model, a training prompt response to a training prompt in the set of training prompts. At block 706, the process, using the training prompt and the training prompt response, trains an attribution model. At block 708, the process, using the trained attribution model and a first prompt response generated by a fine-tuned model in response to a prompt, attributes the fine-tuned model to a foundation model. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (Saas) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
causing generating, by a trained model, a training prompt response to a training prompt in a set of training prompts;
training, using the training prompt and the training prompt response, an attribution model, the training resulting in a trained attribution model; and
attributing, using the trained attribution model and a first prompt response generated by a fine-tuned model in response to a prompt, the fine-tuned model to a foundation model.

2. The computer-implemented method of claim 1, further comprising:
generating, using the trained attribution model and a vocabulary, an additional training prompt; and
adding, to the set of training prompts, the additional training prompt.

3. The computer-implemented method of claim 1, wherein the trained model comprises a trained fine-tuned model.

4. The computer-implemented method of claim 1, wherein the trained model comprises a trained foundation model and a trained fine-tuned model, and the training prompt response comprises a response of the trained foundation model to the training prompt and a response of the trained fine-tuned model to the training prompt.

5. The computer-implemented method of claim 1, wherein the attributing comprises generating a model attribution confidence score.

6. The computer-implemented method of claim 1, wherein the attributing is performed using a pair of prompt responses, the pair of prompt responses comprising the first prompt response and a second prompt response, the second prompt response generated by the foundation model in response to the prompt.

7. A computer program product comprising one or more computer readable storage media, and program instructions collectively stored on the one or more computer readable storage media, the program instructions executable by a processor to cause the processor to perform operations comprising:
causing generating, by a trained model, a training prompt response to a training prompt in a set of training prompts;
training, using the training prompt and the training prompt response, an attribution model, the training resulting in a trained attribution model; and
attributing, using the trained attribution model and a first prompt response generated by a fine-tuned model in response to a prompt, the fine-tuned model to a foundation model.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
generating, using the trained attribution model and a vocabulary, an additional training prompt; and
adding, to the set of training prompts, the additional training prompt.

11. The computer program product of claim 7, wherein the trained model comprises a trained fine-tuned model.

12. The computer program product of claim 7, wherein the trained model comprises a trained foundation model and a trained fine-tuned model, and the training prompt response comprises a response of the trained foundation model to the training prompt and a response of the trained fine-tuned model to the training prompt.

13. The computer program product of claim 7, wherein the attributing comprises generating a model attribution confidence score.

14. The computer program product of claim 7, wherein the attributing is performed using a pair of prompt responses, the pair of prompt responses comprising the first prompt response and a second prompt response, the second prompt response generated by the foundation model in response to the prompt.

15. A computer system comprising a processor and one or more computer readable storage media, and program instructions collectively stored on the one or more computer readable storage media, the program instructions executable by the processor to cause the processor to perform operations comprising:
causing generating, by a trained model, a training prompt response to a training prompt in a set of training prompts;
training, using the training prompt and the training prompt response, an attribution model, the training resulting in a trained attribution model; and
attributing, using the trained attribution model and a first prompt response generated by a fine-tuned model in response to a prompt, the fine-tuned model to a foundation model.

16. The computer system of claim 15, further comprising:
generating, using the trained attribution model and a vocabulary, an additional training prompt; and
adding, to the set of training prompts, the additional training prompt.

17. The computer system of claim 15, wherein the trained model comprises a trained fine-tuned model.

18. The computer system of claim 15, wherein the trained model comprises a trained foundation model and a trained fine-tuned model, and the training prompt response comprises a response of the trained foundation model to the training prompt and a response of the trained fine-tuned model to the training prompt.

19. The computer system of claim 15, wherein the attributing comprises generating a model attribution confidence score.

20. The computer system of claim 15, wherein the attributing is performed using a pair of prompt responses, the pair of prompt responses comprising the first prompt response and a second prompt response, the second prompt response generated by the foundation model in response to the prompt.
